(19) United States
(12) Patent Application Publication
(10) Pub. No.: US 2003/0138002 A1
(43) Pub. Date: Jul. 24, 2003

(54) New materials useful as saturable absorbers

(76) Inventors: Thomas A. Reynolds, Bend, OR (US); Theodore Alekel, Bend, OR (US); Douglas A. Keszler, Corvallis, OR (US)

Correspondence Address: The Halvorson Law Firm, 405 W. Southern Ave., Ste 1, Tempe, AZ, 85282, US

(21) Appl. No.: 09/847,265

(22) Filed: May 2, 2001

(51) Int. Cl. H01S 3/11; H01S 3/113

(52) U.S. Cl. 372/10

(57) ABSTRACT

A material that is a saturable absorber capable of passive Q-switching is provided. In one embodiment the material is a saturable absorber optical compound that forms in an atomic arrangement that comprises boron polyanions and photoactive metal cations. Thus, the present invention encompasses host materials comprising boron polyanions into which suitable photoactive cations are introduced into the four-coordinated zinc site, said photoactive cations capable of producing a saturable absorption effect.

### FIELD OF THE INVENTION

This invention relates to lasers, and, more particularly, to a composition that acts as a saturable absorber for laser systems, a passive Q-switch. More specifically, the present invention is related to saturable absorbers that are comprised of boron-based host materials. Such host materials are crystalline or glass materials having four-fold coordination sites for photoactive metal cations.

### BACKGROUND OF THE INVENTION

A laser is a device that emits a spatially coherent beam of light of a specific wavelength. In a laser, a lasing element is placed within a laser resonator cavity and excited with an energy source, such as optical pumping with a flash lamp or semiconductor laser diode. The pumping action produces stored energy and gain within the lasing element by inverting the equilibrium population of electronic states from ground state energies into excited energy state(s). When the gain exceeds the losses so that there is a net light amplification per round trip of the light in the resonator cavity, laser light begins to build up in the cavity, and stored energy is extracted from the lasing element via transition(s) from excited state to ground state energy. This energy can be expressly released in the form of a very short, intense light pulse by using a device called a Q-switch.

In a Q-switched laser, the quality factor (Q) of the resonant cavity is spoiled and oscillation is prevented until the population inversion has increased well beyond its lasing threshold. The cavity is then suddenly switched on, and a powerful giant pulse is emitted. Typically, lasers are actively Q-switched by using radio frequency-driven electro-optic modulators, rotating mirrors, or total internal reflection techniques. Incorporation of these devices into laser design adds to the complexity and size of the system, and in many cases, may not be practical for miniature and low overhead laser applications.

Another method to Q-switch a laser is to incorporate a saturable absorber as an optical element in the cavity of the laser that requires no additional driving electronics or mechanical devices. This is termed a passive Q-switch, and it operates by initially increasing the cavity losses, thus preventing lasing action, while an amount of stored energy and gain is achieved that greatly exceeds the losses that would otherwise exist. The Q-switch losses are then quickly lowered, producing a large net amplification in the cavity, and an extremely rapid buildup of laser light occurs. The light pulse begins to decay after the stored energy in the lasing element has been depleted such that the gain once again drops below the cavity losses.

The passive Q-switch optical element is a saturable absorber. A saturable absorber is a component that is placed within the optical resonator of the laser, typically between the laser gain element and output mirror as illustrated in FIG. 1. The saturable absorber is a material having transmittance properties that varies as a function of the intensity of the incident light that falls upon the material. When light of low intensity is incident upon the saturable absorber, its light transmittance is relatively low, resulting in high cavity losses. As the incident light energy increases due to the buildup of energy within the laser resonator cavity, the light transmittance of the material increases. At some point, the light transmittance increases to a level such that the material “bleaches”, i.e., becomes transparent, so that the cavity losses become low, and an intense Q-switched light pulse is emitted.

Q-switching is important because it provides short duration optical pulses required for laser ranging, nonlinear studies, medicine, and other important applications. Passive Q-switching using a solid-state saturable absorber Q-switch is economical, simple, and practical when compared to active Q-switching that uses electro-optic or acousto-optic devices and electronic driving circuitry. The advantage of passive Q-switching inheres in its simplicity, reliability, and economy compared to active methods.

The Q-switch material contains an active absorber ion, e.g., Co²⁺, Er³⁺, U²⁺, in a material such as a crystalline or glass host, and in some cases it can be directly bonded to the laser gain element. The desirable properties of a saturable absorber material depend upon the wavelength of the incident light. A material that performs as a saturable absorber at one wavelength typically will not perform in the same manner at significantly different wavelengths. Further, a material may act as a saturable absorber for relatively low incident intensities, but higher intensities may damage the material. Due to the large number of applications requiring passive Q-switching, no material can be considered ideal, and a variety of materials are required to meet the diversified demands. This is particularly the case for passive Q-switch laser operation in the region of 1.3-2.0 μm. Therefore the search for new materials continues.

Some passive Q-switch crystalline materials that have been investigated are U²⁺:CaF₂ (Stultz; 1994-1996), U²⁺:glass (Brunold; 1996), Er:Ca₅(PO₄)₃F (Spariosu; 1999), V³⁺:YAG (Maryvarevich; 1998), Co²⁺:YSGG (Camargo; 1995), Co²⁺:ZnSe (Birnbaum; 1999), and Co²⁺:ZnAl₂O₄ (Brunold, 1996; Gruber, 2000). The uranium-based absorbers suffer from an extended relaxation time, limiting peak powers, and low repetition rate. Er-based absorbers exhibit small absorption cross-sections and narrow bandwidths. Co-based absorbers have high absorption coefficients and short lifetimes, however, in the ZnSe matrix they suffer loss of efficiency due to excited state absorption (ESA). Another main limitation of the above materials is that they demonstrate low optical damage thresholds, ultimately limiting applications where high laser fluence is required.

Therefore there is a present and continuing need for new robust saturable absorbers for use with laser emitters.

### SUMMARY OF THE INVENTION

It is an object of the present invention to provide a Q-switching optical material that comprises boron polyanions and photoactive metal cations.

It is a further object of the present invention to provide a Q-switching optical material comprising boron polyanions and photoactive metal cations that further comprises a chalcogen.

It is yet a further object of the present invention to provide a Q-switching optical material comprising boron polyanions, photoactive metal cations, and chalcogens wherein the material further is capable of producing laser light.

It is another object of the present invention to provide a Q-switching optical material comprising boron polyanions, photoactive metal cations, and chalcogens wherein the material further is capable of optical frequency conversion.

It is yet another object of the present invention to provide a Q-switching optical material comprising boron polyanions, photoactive metal cations, and chalcogens wherein the material further is capable of optical frequency conversion and said medium also contains a metal ion that produces laser light.

It is a further object of the present invention to provide a method for making a Q-switching optical material that comprises boron polyanions and photoactive metal cations.

It is yet a further object of the present invention to provide a method for making a Q-switching optical material comprising boron polyanions and photoactive metal cations that further comprises a chalcogenide.

It is still yet a further object of the present invention to provide method for making a Q-switching optical material comprising boron polyanions, photoactive metal cations, and chalcogens wherein the material further is capable of producing laser light.

It is another object of the present invention to provide a method for making a Q-switching optical material comprising boron polyanions, photoactive metal cations, and chalcogens wherein the material further is capable of optical frequency conversion.

It is yet another object of the present invention to provide a method for making a Q-switching optical material comprising boron polyanions, photoactive metal cations, and chalcogens wherein the material further is capable of optical frequency conversion and said medium also contains a metal ion that produces laser light.

A further object of the present invention to produce and utilize Q-switching optical materials that satisfy the general formula

MᵢZn₄₋ᵢZ(BO₂)₆

wherein Z is a chalcogenide and M is a divalent photoactive metal cation.

It is still yet a further object of the present invention to provide a method for making a Q-switch optical material that satisfies the general formula

M₁Zn₄₋ᵢZ(BO₂)₆

wherein Z is a chalcogenide and M is a divalent photoactive metal cation.

The novel features that are considered characteristic of the invention are set forth with particularity in the appended claims. The invention itself, however, both as to its structure and its operation together with the additional objects and advantages thereof, will best be understood from the following description of the preferred embodiment of the present invention when read in conjunction with the accompanying drawing. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1. Resonator Cavity with Passive Q-Switch.

### DETAILED DESCRIPTION OF THE PREFERRED EMBODIMENTS

The present invention provides materials that can be used for a number of optical applications that include, but are not limited to, passive Q-switching, lasing, and the like. The following paragraphs describe the optical materials, as well as how to make and use the compounds.

In one embodiment of the present invention, the material is a Q-switching optical compound that forms in an atomic arrangement that comprises boron polyanions and photoactive metal cations. Until now, boron-based materials have not been considered for use as host structures that contain photoactive metal ions to provide passive Q-switching functionality. Thus, the present invention encompasses host materials comprising boron polyanions into which suitable photoactive cations are introduced into the four-coordinated zinc site, said photoactive cations capable of producing a saturable absorption effect.

The present invention also encompasses the general formulation below for a passive Q-switch optical compound:

MᵢZn₄₋ᵢZ(BO₂)₆

wherein Z is a chalcogen and M is a divalent photoactive metal cation.

Preferably, oxygen, O, is the chalcogen of choice for the present invention, however, other chalcogens that are desirable, in addition to O, are S, Se, and Te. By incorporating a variety different chalcogen anions into the formulation gives rise to the ability to shift the absorption band of the material, and thereby the wavelength range of saturable absorption. By shifting the absorption band, different and important laser wavelengths are accessible. This accessibility should be tunable by producing solid solutions of the material wherein the different chalcogens are mixed together, in various and known amounts, to control the absorption band energies.

While the divalent photoactive cations that are dopants into the zinc borate chalcogenide materials are preferably selected from the first row transition metals, and more preferably selected from V, Cr, Mn, Fe, Co, Ni, and Cu metals, second, or third row transition metal cations, lanthanide cations, and transuranium cations may also be used. Solid solutions containing various mixtures of cations selected from these metals may also be formed.

It can be seen that the above formulation is a special case of the generalized class of boron polyanion host materials. Thus, it can be seen that the present invention encompasses the boron polyanionic host materials doped with a suitable photoactive cation that creates an absorption band capable of saturable absorption. Doped boron polyanionic materials have never been considered or used as passive Q-switches.

### General Method for Making the Materials

A number of methods, now known or hereinafter developed, can be used to synthesize materials according to the present invention, such as passive Q-switching compounds. In general, and without limitation, these compounds have been synthesized by heating appropriate amounts of starting materials to a temperature sufficient to form the desired materials. The mixture is then ground in a mortar and pestle, heated to a first temperature that generally about 600° C. The mixture is then cooled to room temperature and re-ground, heated a second time to a second temperature higher than the first temperature, such as to a temperature of about 800° C., cooled to room temperature, re-ground and heated to a final temperature of about 900° C. This final heating step continued for a period of time sufficient to form a single-phase product.

Another method by which the compositions of the present invention may be produced is by merely mixing appropriate amounts of starting materials and heated to a temperature necessary to form a single phased product, for example 850° C. Yet another method by which the compositions of the present invention may be produced is using a sol-gel type method, such as mixing soluble salts of the metals into a solution and allowing the solvent and/or reaction by-product to be removed from the solution. Still yet other methods by which the compositions of the present invention may be produced is using chemical vapor deposition, molecular beam epitaxy, and other like methods.

### Working Example

The following example describes a particular embodiment of the present invention. This example should be interpreted as being exemplary of the invention only, and not to limit the invention to the specific features discussed therein.

Co²⁺:Zn₄O(BO₂)₆

### Crystal Growth

Crystals of the material Co²⁺:Zn₄O(BO₂)₆ (zinc metaborate oxide) were grown by the Czochralski method. Starting materials were ZnO, B₂O₃, and Co(NO₃)₂.6H₂O. All materials were specified as 99.999% pure. A charge was melted at 1000° C. in a platinum crucible having a 45 mm diameter. Seed crystals were obtained by slowly cooling the melt at 10° C./h, followed by mechanical extraction. A [100] oriented seed was selected and used for growth with a pulling rate of 0.5 mm/h and a rotation rate of 12 rpm. Crystals obtained in this way were of high optical quality. A section of the crystal was evaluated by X-ray methods for structural conformation, and analytical methods were used to establish the concentration of cobalt as 9.56×10⁸ ions/cm³. For optical studies, the crystal was core-drilled along [100], diced, and polished.

While the preferred embodiment is a crystalline material, polycrystalline and amorphous, or non-crystalline, structures also fall within the scope of the present invention. These materials may be formed using methods such as Czochralski, Bridgemann, Zone-Refining, Top-seeded solution growth, cooling of a melt, hydrothermal, laser pedestal, molecular beam epitaxy, chemical vapor deposition, and sol-gel methods

### Crystal Structure Analysis

Zinc metaborate oxide is a cubic structure having a unit cell of length 7.48 Å. Boron and oxygen form (BO₄)⁻ polyanions where each boron atom is at the center of four tetrahedrally arranged oxygen atoms, a stable arragnement. The zinc atoms occupy irregular tetrahedra where three corners are occupied by oxygen atoms of the metaborate. The corresponding Zn—O bond distance is 1.960 Å, and the O—Zn—O angle is 93.84°. The fourth or “free” oxide anion, which is located at the remaining corner, has Zn—O bond distance of 1.987 Å, and the O—Zn—O angle between the metaborate oxygen and the free oxygen is 121.49°. Thus, it can be seen that the zinc atom occupies a site of fourfold coordination.

### Spectroscopic Analysis

Low-temperature absorption spectra of Co²⁺ in the zinc metaborate oxide were obtained with an upgraded Cary model-14R spectrophotometer controlled by a desktop computer. The sample was mounted at the cold finger of a CTI model-22 closed-cycle helium cryogenic refrigerator capable of operation between 8 and 300° K. The sample temperature was monitored with a silicon diode sensor attached to the base of the sample holder and maintained by using a LakeShore control unit. Spectra were taken at 8° K, ranging from 300 to 2600 nm. The spectral bandwidth was set at 0.5 nm, and the instrument was internally calibrated to an accuracy of 0.3 nm. The spectra were analyzed and plotted by using the computer software Sigma Plot.

Fluorescence spectra were measured on samples at 8° K with a right-angle spectrophotometer equipped with a ⅛ meter focal length monochromator. The wavelength range was scanned from 400 to 1700 nm, but fluorescence was observed only between 555 and 855 nm. A Hamamatsu R636 and R1767 PMTs and a Northeast Optical Ge detector were used to collect the spectra. The sample was mounted on the cold finger of a Cryo Industries (Model CRG-102) cryostat, and the temperature was controlled by a Conductus LTC-10 controller. Excitation light was provided by a 300 W Xe lamp dispersed through a Cary Model-15 double prism monochromator at 360 nm.

The absorption spectrum of Co²⁺ in zinc metaborate oxide at 8° K is illustrated in FIGS. 2 and 3. The spectrum is characterized by several strong bands consisting of sharp absorption peaks near 544 and 640 nm (FIG. 2) and absorption peaks observed between 1300 and 1500 nm (FIG. 3). Weaker bands with associated absorption peaks are observed near 600 nm and 2400 nm. The strong absorption band observed between 1300 and 1500 nm includes vibronic and electronic transitions from ⁴A₂ (⁴F) to the excited state ⁴T₁ (⁴F) state. This band has a sufficiently high absorption cross section to be used as a saturable absorption medium for lasers that emit at theses wavelengths.

The fluorescence spectrum obtained at 8° K is shown in FIG. 4. A strong emission band is observed at 574 nm and a seeker band with structure is found between 600 and 855 nm. The weaker fluorescence band in FIG. 4 represents vibronic and electronic transitions. This weak emission is considered to be due to Co²⁺ possibly associated with a charge-transfer band (viz. ZnO—Co²⁺). The relatively strong absorption band between 448 and 560 nm suggests a strong coupling between the energy states of Co²⁺ and a zinc borate band. An excitation scan of the 574 nm emission band and the broad band revealed that weak luminescence can occur. The integrated luminescence intensity of both bands decreased with increasing temperature, providing evidence for phonon-assisted relaxation. A complete analysis of potential d-d electronic transitions and their vibronic counterparts did not allow satisfactory explanation of the observed luminescence. Therefore it is suggested that the emission originates from a charge-transfer band. The low luminescence quantum efficiency and temperature dependence of the emission provide evidence for strong quenching of luminescence due to non-radiative relaxation processes. The optical absorption and fluorescence spectra of Co²⁺ in zinc metaborate oxide can be interpreted in terms of Co²⁺ ions substituting for Zn²⁺ in the lattice with the assumption of a C₃ᵥ cationic site.

### Borate Materials

It is also noted that borate-based materials form a large group of inorganic materials that have useful optical properties, in addition to the above-discussed saturable absorption. They are used in optical devices including glass lenses, windows, fiber optics, laser gain media, and nonlinear optical crystals for production of laser light. A main advantage of borate materials, particularly for use with laser light is their high optical damage threshold. Damage thresholds from up to 10×10⁹ W/cm² are reported for the common NLO borates β-BaB₂O₄ (BBO), and 25×10⁹ W/cm² for LiB₃O₅ (LBO).

Thus the present invention includes borate materials that may demonstrate optical properties in addition to saturable absorption, such as frequency doubling, optical parametric oscillation, laser light generation, and the like. More specifically, as demonstrated in the working example discussed above, these borates may possess a fluorescence band (such as the one observed at 576 nm in the working example) that is suitable for the generation of laser light. Also, photoactive metals that generate or are capable of generating these fluorescence bands may be doped into to the borate structures (these photoactive cations may be the same cations that create the saturable absorption effect or they may be different cations that are doped into the structure in addition to the cations that create the saturable absorption effect). Therefore, the borate material may be in a non-centrosymmetric structure (which would allow for nonlinear optical effects) and still serve as a host material for the photoactive cations that create the saturable absorption or laser light emission effects.

### Optical Properties (Q-switch)

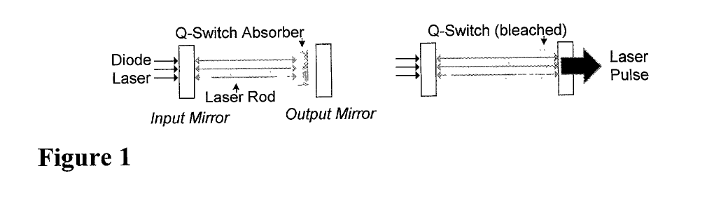

FIG. 1 schematically illustrates a laser system. The laser system includes a laser resonator cavity having a resonant axis. At a first end of the cavity is a flat mirror, which has a reflectivity of substantially 100 percent. At a second end of the cavity is an outcoupler mirror having a reflectivity that is less than 100 percent. A focusing lens is optionally provided adjacent to the second end of the cavity.

A lasing element is positioned within the laser resonator cavity. In one form of laser, the lasing element is in the form of a cylindrical solid rod whose cylindrical axis coincides with the resonant axis. When stimulated, the lasing element emits coherent light having a wavelength, for example in a range at about 1.5 micrometers, and more specifically from about 1.4 to about 1.65 micrometers. Examples of materials operable as such a lasing element include Er:glass (erbium doped into a phosphate glass host) and Er³⁺:YAG (erbium doped into a yttrium-aluminum garnet host). These lasing elements are all known in the art.

A means for optically pumping the lasing element is provided. Typically, also provided is an optical element which, at a 45° angle of incidence, has a high transmittance at the pumping wavelength and a high reflectivity at the lasing wavelength.

A Q-switch crystal, according to the present invention, is positioned within the laser resonator cavity with the resonant axis passing therethrough. The Q-switch crystal lies between the lasing element and the outcoupler mirror. In one embodiment, the Q-switch crystal could lie between the focusing lens and the outcoupler mirror, so that the resonant light beam is focused into the Q-switch crystal by the focusing lens. For this embodiment, the Q-switch crystal is a saturable absorber of light in the wavelength range at about 1.5 micrometers, and more specifically from about 1.4 to about 1.65 micrometers. The Q-switch material desirably has a higher absorption cross-section, preferably a much higher absorption cross section, than the stimulated emission cross section of the lasing element. Alternately, the saturable absorber, according to the present invention, may be coated, bonded or otherwise attached to another optical material, such as a lens, frequency double, or the like.

The preferred embodiment of the invention is described above in the Drawing and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A saturable absorber Q-switch medium comprising: a material comprising boron polyanions and photoactive metal cations, wherein the said photoactive metal cations are selected from cations capable of demonstrating passive Q-switching and can be selected from the first, second, or third row transition metal cations, lanthanide cations, and transuranium cations; and said material has sites of geometry suitable for coordinating said metal cation and is suitable to be used with excitation means associated with the medium for pumping optical energy into the energy levels of the metal cation to produce a Q-switching function.

2. The saturable absorber Q-switch medium of claim 1 wherein, said Q-switch medium is selected from the group consisting of single crystalline material, polycrystalline material, and an amorphous material.

3. The saturable absorber Q-switch medium of claim 1 wherein, said material of the Q-switch medium further comprises a chalcogen.

4. The saturable absorber Q-switch medium of claim 1 wherein, said Q-switch medium is bonded to another optical material.

5. The saturable absorber Q-switch medium of claim 1 wherein, said Q-switch medium is coated onto another optical material.

6. The saturable absorber Q-switch medium of claim 1 wherein, said Q-switch medium contains a metal cation that produces laser light.

7. The saturable absorber Q-switch medium of claim 1 wherein, said medium is a nonlinear optical material and capable of optical frequency conversion.

8. The saturable absorber Q-switch medium of claim 1 wherein, said medium is a nonlinear optical material and capable of optical frequency conversion and said medium also contains a metal cation that produces laser light.

9. A method for making a saturable absorber Q-switch medium comprising borate polyanions and a photoactive metal cation comprising the steps of: forming a mixture of appropriate starting materials; heating said mixture to a temperature sufficient to form the absorber medium.

10. The method for making a saturable absorber Q-switch medium according to claim 9 further including the step of refining the saturable absorber Q-switch medium using refinement techniques selected from the group consisting of Czochralski, Bridgemann, Zone-Refining, Top-seeded solution growth, cooling of a melt, hydrothermal, laser pedestal, molecular beam epitaxy, chemical vapor deposition, and sol-gel methods.

11. The method for making a saturable absorber Q-switch medium according to claim 9 further including the steps further heating to a temperature sufficient to melt the material, followed by cooling the melt.

12. An optical device comprising: a laser for producing laser light having a resonant cavity that contains a passive saturable Q-switch absorber medium lying within the resonant cavity, and said medium comprising a boron polyanion and a photoactive metal cation and is responsive to said laser light to produce a Q-switch function.

13. The device of claim 12 wherein said Q-switch medium is selected from the group consisting of single crystalline material, polycrystalline material, and an amorphous material.

14. The device of claim 12 wherein said material of the Q-switch medium further comprises a chalcogen.

15. The device of claim 12 wherein said Q-switch medium is bonded to another optical material.

16. The device of claim 12 wherein said Q-switch medium is coated onto another optical material.

17. The device of claim 12 wherein said Q-switch medium contains a metal cation that produces laser light.

18. The device of claim 12 wherein said medium is a nonlinear optical material and capable of optical frequency conversion.

19. The device of claim 12 wherein said resonant cavity further contains a material capable of frequency conversion.

20. The device of claim 12 further including a material capable of frequency conversion, said material located external to the resonant cavity of the laser.

21. The device of claim 12 wherein said medium is a nonlinear optical material and capable of optical frequency conversion and said medium also contains a metal ion that produces laser light.

22. A saturable absorber Q-switch medium comprising the general formula NM²⁺:Zn₄X(BO₂)₆, wherein X is a chalcogen and M is a photoactive divalent metal cation, wherein the said photoactive divalent metal cation is selected from cations capable of demonstrating passive Q-switching and can be selected from the first row transition metal cations; and said material has sites of geometry suitable for coordinating said metal cation and is suitable to be used with excitation means associated with the medium for pumping optical energy into the energy levels of the metal cation to produce a Q-switching function.

23. The saturable absorber Q-switch medium of claim 20 wherein, said Q-switch medium is selected from the group consisting of single crystalline material, polycrystalline material, and an amorphous material.

24. The saturable absorber Q-switch medium of claim 20 wherein, the chalcogen is selected from the group consisting of O, S, Se, and Te.

25. The saturable absorber Q-switch medium of claim 20 wherein the divalent metal cation is selected from the group consisting of Mn, Fe, Co, Ni, and Cu metals.

26. The saturable absorber Q-switch medium of claim 20 wherein, said Q-switch medium is bonded to another optical material.

27. The saturable absorber Q-switch medium of claim 20 wherein, said Q-switch medium is coated onto another optical material.

28. The saturable absorber Q-switch medium of claim 20 wherein, said Q-switch medium contains a metal ion that produces laser light when excited.

29. A method for making a saturable absorber Q-switch medium having the general formula M²⁺:Zn₄X(BO₂)₆, wherein X is a chalcogen and M is a photoactive divalent metal cation, wherein the said photoactive divalent metal cation is selected from cations capable of demonstrating passive Q-switching comprising the steps of: forming a mixture of appropriate starting materials; heating said mixture to a temperature sufficient to form the absorber medium.

30. The method for making a saturable absorber Q-switch medium according to claim 27 further including the step of refining the saturable absorber Q-switch medium using refinement techniques selected from the group consisting of Czochralski, Bridgemann, Zone-Refining, Top-seeded solution growth, cooling of a melt, hydrothermal, laser pedestal, molecular beam epitaxy, chemical vapor deposition, and sol-gel methods.

31. The method for making a saturable absorber Q-switch medium according to claim 27 further including the steps further heating to a temperature sufficient to melt the material, followed by cooling the melt.

32. An optical device comprising: a laser for producing laser light having a resonant cavity that contains a passive saturable Q-switch absorber medium lying within the resonant cavity, and said medium the general formula M²⁺:Zn₄X(BO₂)₆, wherein X is a chalcogen and M is a photoactive divalent metal cation, wherein the said photoactive divalent metal cation is selected from cations capable of demonstrating passive Q-switching.

33. The device of claim 30 wherein, said Q-switch medium is selected from the group consisting of single crystalline material, polycrystalline material, and an amorphous material.

34. The device of claim 30 wherein, said Q-switch medium is bonded to another optical material.

35. The device of claim 30 wherein, said Q-switch medium is coated onto another optical material.

36. The device of claim 30 wherein, said Q-switch medium contains a metal cation that produces laser light when excited.
